(19) United States
(12) Patent Application Publication
(10) Pub. No.: US 2009/0124157 A1
(43) Pub. Date: May 14, 2009

(54) ABRASIVE CLEANING ITEM CONTAINING AN AGENT WHICH PROMOTES THE CREATION OF FOAM WHEN IN CONTACT WITH WATER TO TREAT SURFACES

(76) Inventors: Nohemi Garza, San Luis Potosi (MX); Mauricio Ruiz, San Luis Potosi (MX); Raul Maldonado Arellano, San Luis Potosi (MX)

Correspondence Address: 3M INNOVATIVE PROPERTIES COMPANY, PO BOX 33427, ST. PAUL, MN, 55133-3427, US

(21) Appl. No.: 12/090,432

(22) PCT Filed: Oct. 19, 2006
(86) PCT No.: PCT/US2006/040809

§ 371 Date: Aug. 21, 2008

(30) Foreign Application Priority Data
Oct. 21, 2005 (MX) 2005011412

(51) Int. Cl. B32B 5/24; B32B 37/02

(52) U.S. Cl. 442/370; 156/60

(57) ABSTRACT

The present invention is related to an abrasive cleaning item, comprising abrasive particles and a foaming agent which may or may not be microencapsulated particles distributed throughout a body of non-woven tri-dimensional fiber. The item, which may have any geometric configuration, offers the user the advantage of being able to have a cleaning product which, during a period of time similar or shorter than the useful life of the non-woven web laminated to the polyurethane foam, the foaming agent is diluted by its aqueous extraction and produces the foam effect or, otherwise, the microcapsules are slowly released by the mechanical effect of the cleaning.

### FIELD

The present invention is related to an abrasive cleaning item of any geometric configuration and, particularly, pertains to an abrasive product that has as a characteristic, foam generation through the addition of a chemical agent that promotes foam production; such peculiarity promotes the use of a smaller quantity of detergent at the time of washing kitchen utensils or other surfaces, resulting from the concept correlating amount of foam generated to cleaning power, which in this case is provided by a chemical agent similar to that used in equivalent amounts of detergent.

### BACKGROUND

The current state of the art deals with several types of “woven fabrics, non-woven fabrics and pads” that include some lubricating and abrasive agent which offers the user an enhancement when performing home cleaning activities.

U.S. Pat. No. 4,071,333 (Like) mentions ethoxylated foaming agents, used for the purpose to manufacture an abrasive block to perform the functions of carving and washing. The block is formulated with ethoxylated foamers, and constitutes the washing system itself. The patent does not contemplate adding a foaming agent as an external agent to a fiber and foam device, but it refers to a cleaning block formulated with a nonionic detergent, an abrasive material, and a long chain fatty alcohol, dealing more with the cleaning agent. The patent also makes reference to linear chain ethoxylated alcohols as a material of high fusion point to manufacture the block or, otherwise, to combine it with an ethoxylated alkyl-phenol. Linear chain alcohols with a content of at least 12 condensed carbons with 12 to 40 moles of ethylene oxide are included. Linear chain alcohols from 16 to 18 carbon atoms are preferred. It mentions as an example Alfonic 1618-65, which is a mixture of C16 and C18 alcohols containing about 65% of ethylene oxide. In this case, the composition of the cleaning block is defined as:

65-85% by weight of abrasive (sand)

10-20% by weight of nonionic detergent having a high fusion point (polyethoxylated alkyl-phenols or polyethoxylated fatty alcohols of linear chain with ethylene oxide).

5-15% by weight of linear chain fatty alcohol (C16-C18).

From 1 to 3% by weight of a sodium alkyl-sulfate (C12-C14).

U.S. Pat. No. 4,175,051 (Imamura, et al.) pertains to an abrasive pad containing soap. The pad comprises fine metal wires and a detergent composition impregnated on the pad. It does not make any reference to any foaming agent to increase or improve the foam of the added detergent; in addition, the pad is limited to the metal wires composition. The composition of the detergent comprises essentially from 5 to 40% by weight of one or of a mixture of phosphoric acid ester salts having the formula I) [R(OCH2 CH2)ₘ]ₓ PO4H3-x-y My (I) wherein R is an alkyl or alkenyl having 10 to 22 carbon atoms or allylphenyl having 6 to 18 carbon atoms. Said alkyls or alkenyls can be linear or branched, “m” is from 0 to 10, “x” is from 1.0 to 2.0, “y” has values from 0.5 to 2.0, with the proviso that the sum of “x” and “y” does not exceed 3, and “M” is an alkali metal, ammonium, alkanolamine, alkaline earth metal, zinc or aluminum cation.

From 50 to 95% by weight of a fatty acid soap having 10 to 22 carbon atoms is added; the weight ratio of the detergent composition in relation to the metal pad is from 0.2/1 to 2.0/1. The detergent composition contains from 0 to 20% by weight of water-soluble, non-soap anionic, nonionic or amphoteric surfactant different from the phosphoric acid ester salt, or water-soluble inorganic salts or mixtures thereof.

U.S. Pat. No. 3,968,058 (Cheng) relates to a method of forming urea-inclusion compounds and ethoxylated long chain liquid alcohols, non-tacky and which contain about 60 to 65% by weight (preferably more than 50%) of ethoxamer. The method includes the preparation of an urea and organic solvent suspension before mixing the urea and the ethoxamer; it provides a greater amount of ethoxamer by weight in the inclusion compound. It claims the method to form a mixture of urea and ethoxylated long chain liquid alcohol containing an alkali from 12 to 18 carbon atoms and an average 10 to 19 ethylene oxide, including the steps to prepare an urea emulsion with particle sizes smaller than 74 microns and methanol. The enhancement does not make any reference to a cleaning pad with a foaming agent added.

U.S. Pat. No. 5,542,950 (Cole, et al.) pertains to an invention relating to the composition and the scouring and bleaching process of textile materials. In particular, that by combining alkyl polyglycosides containing primary linear alcohols with an ethoxylated primary linear alcohol, a scouring and bleaching synergy effect occurs. By adding a chlorine-capped ethoxylated isodecyl alcohol to the scouring and washing composition, a smaller amount of foam is generated. The patent mentions the washing and finishing processes, but it does not make any reference to an improvement in the cleaning pad by the action of a foaming agent. It mentions that there are different textile finishing processes where the formation of the textile fibers are subject to alteration. This invention discusses the materials that act as loads, lubricants and other impurities that are contained in or adhere to the fibers during their manufacture. These impurities must be removed from the textile material so that the textile fibers may be further processed. Other finishing processes involve bleaching, whereby a white color is imparted to the textile. This bleaching step enhances the absorbency of the fiber materials in preparation for the application of other finishing processes as well as the removal of any residual impurities left over from the scouring process. Thus, the main purpose of this invention is to provide a more effective means of cleaning and bleaching textile fibers without harming the environment.

Another aspect of the mentioned invention is the reduction of foam generation associated with the use of allkyl-polyglycoside surfactants. A composition of surfactant to be used in the scouring and bleaching of textile materials while foam generation is controlled includes, a) from 6% to 94% by weight of a polyglycoside alkyl having the general formula IRO (Z)a (I), wherein R is a monovalent organic radical having from 8 to 16 carbon atoms; Z is a saccharide residue having 5 or 6 carbon atoms; and a is a number having a value from 1 to 6; b) from 94% to 6% by weight of a chlorine-capped ethoxylated isodecyl alcohol; and (c) the remainder water, all weights being based on the weight of the composition. The composition mentioned above also claims, where the chlorine-capped ethoxylated isodecyl alcohol contains from 6 to 10 moles of ethylene oxide, the process to scour and bleach the textile materials while foam generation is being controlled, including adding a bath of an aqueous solution and a bleaching bath from 0.1 to 1.0% by weight of the surfactant composition, having, (a) from 6% to 94% by weight of a polyglycoside alkyl having the general formula IRO (Z)a (I), wherein R is a monovalent organic radical having from 8 to 16 carbon atoms; Z is a saccharide residue having 5 or 6 carbon atoms; and a is a number having a value from 1 to 6; b) from 94% to 6% by weight of a chlorine-capped ethoxylated isodecyl alcohol; and (c) the remainder water, all weights being based on the weight of the composition and subjecting the mentioned textiles to the mentioned bath.

### SUMMARY

The present invention provides an enhanced cleaning product, which being a laminated non-woven web with a foam sponge would have a foaming agent promoting the generation of foam and helping increase the durability of the foam generated when kitchen utensils or other surfaces are washed with detergent. This is advantageous because it reduces consumption of detergent when washing kitchen utensils or surfaces because in the minds of users, a greater amount of foam suggests greater cleaning power. The foaming agent is of such a nature that is compatible with the detergents commonly used for cleaning kitchen utensils and surfaces.

In one aspect, the foaming agent is a chemical agent belonging to the family of ionic, nonionic or amphoteric surfactants of linear or branched structure, coco betaine, substituted mono-, di- or tri-amines, ethoxylated alcohols. In a specific embodiment, the foaming agent is of the amphoteric surfactants family.

In another embodiment of this invention, an item having the gradual extraction of the foaming agent through the wash/rinse water used to clean surfaces or kitchen utensils, or by breakage of the microcapsules which may contain or not the foaming agent; through the mechanical action from scouring the abrasive item against the object being cleaned.

### BRIEF DESCRIPTION OF THE DRAWINGS

FIG. 1 is a side view of the abrasive product according to one embodiment of this invention. In this figure is represented: the sponge foam base made of polyurethane, cellulose, polyethylene, melamine or polypropylene (1), a non-woven material made of natural or synthetic fibers, manufactured with an adhesive which includes phenolic resins or acrylic emulsions and may or may not contain minerals such as talc, carbonates, PVC, silica and metal oxides (2), acrylic- or epoxy-based polyurethane adhesive, or isocyanates or combinations rubber-resin; resins derived from starches, cellulose derivatives or proteins are also included, or hot melt-type systems or systems where, through the direct addition of chemical substances, sponge foam generation is directly promoted over the web of the non-woven material (3).

FIG. 2 shows the preferred laminating process for the execution of the invention, where is seen the non-woven web pad entering the rollers (1), the rollers (2), the solution with the adhesive, deposited on the rollers (3), the moisture spray guns where the foaming agent is sprayed (4), the sponge foam roll (5) and the final roll of the non-woven web laminated to the sponge foam containing the foaming agent (6).

FIG. 3 shows the type of construction preferred in this invention of the rollers used for the type of impregnation of the adhesive on the web of non-woven material which is subsequently bonded to the sponge foam; when the non-woven web enters the manufacturing station is shown as number (1); the adhesive solution coating the roller and which is used to bond the non-woven web and the sponge foam is represented by number (2) and the tray where the polyurethane-based adhesive (methyl diisocyanate or MDI) is deposited is represented by number (3).

FIG. 4 represents the surface tension curve compared to the surfactant concentration (10000 ppm=1%).

FIG. 5 represents the curve of determination of the time of duration of the foaming agent compared to washing time.

### DETAILED SHORT DESCRIPTION OF THE INVENTION

The present invention provides a novel cleaning item, for kitchen utensils as well as for general cleaning applications, which comprises three-dimensional non-woven web constituted by a non-woven material and adhesives, and which has in its body, a foaming agent which may or may not be microencapsulated and which helps generate foam without the need to use detergent. It also promotes the generation of foam, resulting as benefit then, that a smaller amount of detergent is needed to create a high foam level, satisfying thus the need based on the general idea that the greater the amount of foam, the greater is the cleaning power. The foaming agent being or not microencapsulated may be trapped in the adhesive matrix that bonds the sponge foam to the non-woven web, or in the cells of the sponge foam or in the non-woven web itself.

The foaming agent may or may not be in microcapsules distributed throughout the body of the non-woven web laminated to the sponge foam, and it can be released through: the breakage of the microencapsulated spheres resulting from the manual mechanical scouring action over the surface to be treated with the non-woven web pad laminated to the sponge foam (1), the breaking up of the spheres by the action of the water used to wash the surfaces or utensils (2), the dilution of the foaming agent found in the polymer matrix of the adhesive bonding the sponge foam to the web of the non-woven material by the action of the water used to wash surfaces or utensils (3), or the dilution of the foaming agent trapped in the cells of the sponge foam by the action of the water used to wash the surface or utensil being cleaned (4) or the release of the foaming agent by its dilution in the water used to wash the surface or utensil, when the foaming agent is incorporated into the polymer structure of the non-woven material (5).

The microcapsules having cellulose acetate or acrylic polymer structure are insoluble in water and are manufactured with a controlled permeability.

Such particles are able to break up to gradually release the foaming agent therein contained. This characteristic is important to insure that the microcapsules are capable of withstanding the washing conditions, in addition to insuring that they gradually wear out.

The direct addition of the foaming agent in the polymer matrix of the adhesive, in the sponge foam or incorporated into the polymer structure of the non-woven material, allows the gradual release by dilution of the foaming agent into the wash/rinse water and, in general, is the manner preferred in this invention to incorporate the foaming agent to the non-woven web laminated to the sponge foam.

The procedure to manufacture the cleaning pad comprising the non-woven web laminated to the sponge foam is already known in the state of the art and comprises the following steps: preparation of the body of the non-woven web starting from polymer fibers of nylon, polyester, polypropylene or rayon, or natural fibers which may be jute, bamboo, cane or cotton (1); application of an adhesive containing the abrasive particles, pigments, surfactants and mineral in suspension, to bond the non-woven web, using an impregnation or application process comprising rollers and spraying (2); curing of the adhesive in an oven at a temperature which may range between 80 and 200° C. (3); bonding of the non-woven web to the sponge foam, which may be polyurethane-, melamine- or cellulose-based, using a polyurethane-based adhesive (Methyl diisocyanate or MDI), or bonded by means of a hot melt-type system or by the growth of the sponge foam by incorporating chemical substances on the non-woven web (4).

The incorporation of the foaming agent may be accomplished by any of the following methods: by adding it when preparing the adhesive which is applied by rollers or spraying to the substrate of the non-woven web in the impregnation stage (1) or, by applying the foaming agent in a solution of known concentration, which may range between 1% to 40% by weight, on the body of the non-woven web or of the sponge foam (2), during the spraying of the polyurethane-based adhesive (methyl diisocyanate or MDI) in the spraying step of the lamination process (see FIG. 2, step 4) being this last option the preferred execution of the invention.

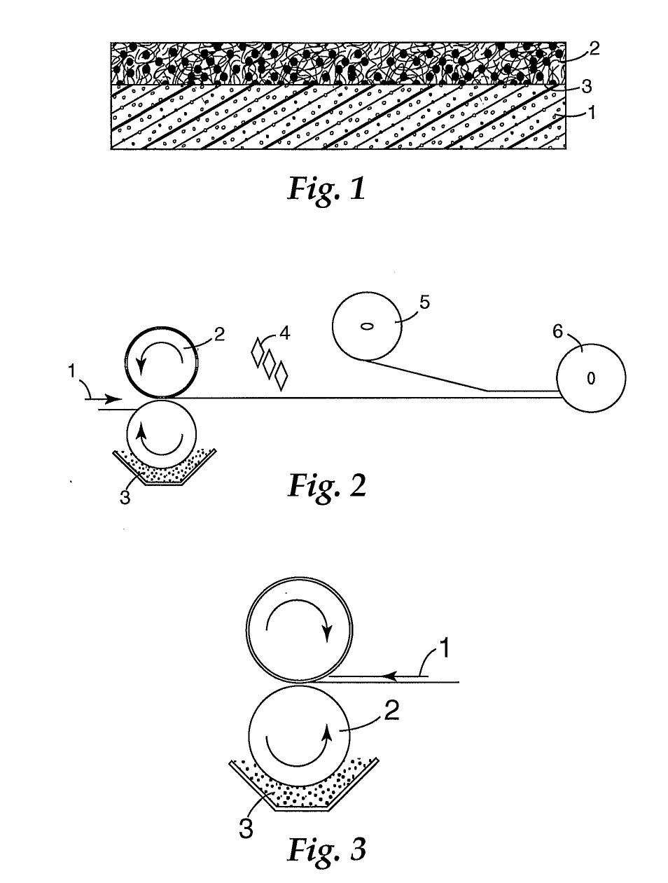

A cleaning item as the one shown in FIG. 1 is provided, which has the advantage of having incorporated into it, a foaming agent that promotes foam generation, being the foam level a parameter directly related to the cleaning power of a detergent, therefore, because this new product promotes foam production, the detergent may be used in smaller quantities and, with the help of the item, it may continue to generate the same or greater amount of foam. The cleaning item comprises a core of material formed mainly from synthetic non-woven fibers which may be nylon, polyester, polypropylene or rayon, or natural fibers such as jute, cane, cotton or others which are bonded at their contact points by a phenolic resin or an acrylic emulsion, which is selected for the preparation of the adhesive that coats the bonded non-woven web and which subsequently is bonded to a polyurethane-, melamine- or cellulose-based sponge foam by means of a lamination process, using polyurethane-based adhesive (methyl diisocyanate or MDI), a system utilizing hot-melt adhesive or a system which, through the addition of chemical substances, the growth of the sponge foam on the non-woven web is promoted.

The adhesive may or may not contain the abrasive particles selected from the group of silicas, carbonates, silicon, silicates, talcs, metal oxides, PVC, melamine, etc., among others.

As raw materials for the formation of the non-woven web are used natural or synthetic fibers of 17, 70, 110, 120 and 200 deniers; the fiber used in one embodiment of the invention is a non-woven synthetic fiber staple 6.6, preferably of polyamide nylon, with a circular cross section; the non-woven web is formed in a machine called “Rando Webber” (from Rando Machine Company, New York) through a process which is already known in the state of the art.

The non-woven web is coated with an adhesive impregnated by rollers, process known as “Impregnation by rollers”; at this stage of the process, the non-woven web is run through the rollers and the rollers at the same time deposit inside the non-woven web a solution consisting mainly of phenolic resin or acrylic emulsion, or a mixture thereof, which acts as an agglomerating or bonding agent, giving thus “body” or consistency to the non-woven web.

The two rollers are made of different materials: One is made of “Buna” nitrile rubber, and the other is made of metal. Both rollers have three-dimensional design (knurled), where the adhesive is deposited. The rotating roller carries the adhesive and deposits it inside the structure of the non-woven web by applying pressure against the other roller.

In this station of impregnation of adhesive by the rollers, the frame that supports the rollers has the capability to open and close as necessary, depending on the thickness of the non-woven web being processed; the variable roller pressure allows the adjustment of the amount of adhesive deposited on the non-woven web.

The solution containing the adhesive is kept in a holding tray located below the rollers, similar to the one shown in FIG. 3 and, during the impregnation process, the amount of adhesive deposited on the rollers must be kept constant; the adhesive must be supplied from a container filled with the adhesive.

In one of the walls of this tray there is a hole which allows the draining of the excess of adhesive once it reaches a certain level; the tray also has another hole in its bottom part which is used to drain the remaining adhesive once the operation ends.

Immediately after the adhesive is deposited by the rollers, the non-woven web is conveyed on a metal belt toward the oven entrance, which has previously been warmed to a temperature of between 80 and 200° C.

Second stage of the process: Application of a coating by spraying or sprinkling. In this stage, the first of two coating solutions containing the abrasive material is applied.

The material, coming from the first stage of the process, enters a spray booth where the adhesive is applied in small drops created with a spray mechanism and particularly, one spraying gun specially designed to dosify solutions or emulsions with high solid content, forming thus the spray coat.

This spray coat solution must be prepared prior to the start of the process, making sure always that it is totally homogeneous, because it may or may not contain very dense abrasive material which may settle on the bottom of the container; this solution must be kept continuously stirred inside the container and the container must also be pressurized to allow the pumping of the solution toward the spray gun that will spray the solution at a certain pressure which may range between 60 and 100 pounds/in2, on the non-woven web.

After this first spraying process, the material having the spray solution coat still wet, is conveyed by the metal belt toward the oven for drying and curing; the temperature of the oven may range between 80 and 200° C.

The third stage of the process comprises the application of the coating on the second side of the material by spraying it (spray coat).

In this step, the same process as the one described in the second step is followed, but it is performed on the opposite side of the material. The process is exactly the same, including the part of the process consisting of curing the material containing the solution. At the end of the curing time, the material is wound up to make a roll of different dimensions becoming the final product.

Up to here we have described the manufacturing of the non-woven web. The following step is the lamination of the non-woven web to the sponge foam.

The non-woven web pad is bonded to a sponge foam by means of a polyurethane-based adhesive (Methyl diisocyanate or MDI), by using an acrylic or epoxy based adhesive, or with an adhesive consisting of rubber-resin combinations. The sponge foam may be of a polyester-based polyurethane, polyether or poliol, or otherwise, a cellulose sponge foam or melamine.

The three-dimensional web of the non-woven material enters the rollers where the polyurethane-based adhesive (methyl diisocyanates or MDI) is applied on one of its two sides. Then the material passes to a metal belt which conveys it to the moisturing spray nozzles of controlled pressure and flow, where the impregnation of the foaming agent takes place. The material continues being conveyed by the belt and is bonded to the sponge foam. At this point, the material later may or may not be impregnated through a system of nozzles which contain the foaming agent which is directly sprayed on the sponge foam. The product is then wound up and held together with a packaging adhesive tape which applies pressure to it, in order to cure the adhesive and, therefore, to achieve the bonding of the non-woven web to the sponge foam.

In the case of the lamination with hot melt-type adhesive, the process begins when a rake begins spreading evenly a hot melt adhesive on the sponge foam. The adhesive has been previously warmed to a temperature not higher than 300° C. Once the sponge foam has been coated with the adhesive, it is bonded to the non-woven web to form the final product.

In the case of the lamination process where the sponge foam is made to grow directly on the non-woven web, the process starts when Glauber salt and pigments are mixed to form a mixture which is then extruded into a sheet and which is laid over the non-woven web; next, this material goes through an electric oven where it is dried. Next, an acid bath cleans the sponge foam and removes the excess of salt, adding at the same time a softener. In this step and as the final step, the sponge foam already laminated to the non-woven web is cut and packaged.

The formulations to be used in the preferred embodiment of this invention are shown below:

| | |
|---|---|
| Component | % |

Non-woven web

| | |
|---|---|
| Sinthetic fiber | 100% |

Adhesives impregnated by rollers and spraying

| | |
|---|---|
| Resin | 40-85 |
| Pigments | 0.5-2 |
| Antifoaming agents | <2 |
| Mineral | 50-80 |
| Bactericide | <2 |

The foaming agent may be an amphoteric compound derived from ammonia salts. The carbon chain is allyl type and may contain from 1 to 17 carbons.

The peculiarity of the present invention is associated to the production of the abrasive item with foaming agent, starting from the following principles:
(1) The selection of the combinations of formulations containing minerals and polymers and the amount of foaming agent to be included so that the final product performs well.
(2) The selection of the adequate thickness of the non-woven web, allowing it to maintain the necessary strength value and structure to contain the foaming agent distributed throughout its structure, insuring the functionality of the product.
(3) The selection of the adequate amount of foaming agent necessary to provide a good performance of the final product.

It has been found that the duration of the foaming agent is very much tied to the frequency and mode of use on surfaces or kitchen utensils. The amount of foaming agent can be adjusted to different levels to achieve different lengths of usage time according to the needs of the user.

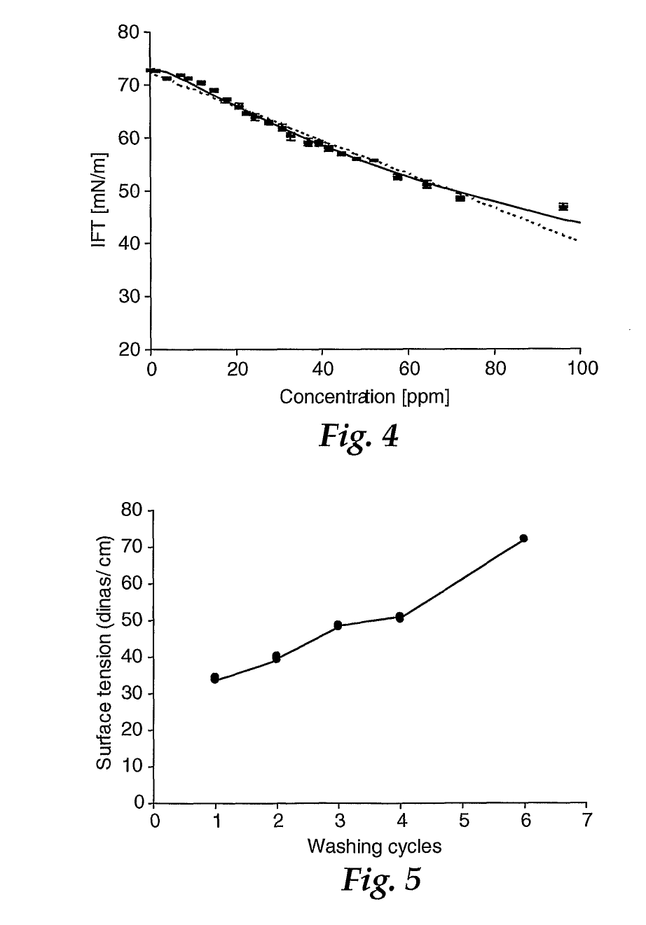

To determine the amount of foaming agent applied and how long it lasts, a standard was established where the surface tension of a solution containing the foaming agent contained in the final product of this invention is correlated to the concentration of the foaming agent in the solution, a standard curve using the pendant drop method was constructed. The results can be observed in FIG. 4, where the dotted line represents the model y=ax+b, and the solid line y=(ax+b)/(cx²+dx+e).

The model having the second-degree polynomial in the denominator was selected. The study of the adjustment appears in Table 1.

TABLE 1
Models to adjust the experimental points of Graph 1.

| | y = ax + b | $y = \frac{ax + b}{{cx}^{2} + dx + e}$ |
|---|---|---|
| a | 1.18 × 10³ | -3.20 × 10⁻¹ |
| b | 3.81 × 10³ | 7.23 × 10¹ |
| c | 1.15 × 10⁻¹ | |
| d | 1.59 × 10¹ | |
| e | 5.25 × 10¹ | |
| Log U | 1.1472 | 1.7271 |

Wherein U = Σ (Y_{calculado} − Yₑₓₚₑᵣᵢₘₑₙₜₐₗ)²
(Y_{calculado} = Y_{calculated}
Yₑₓₚₑᵣᵢₘₑₙₜₐₗ = Yₑₓₚₑᵣᵢₘₑₙₜₐₗ₎

Next, a percentage of foaming agent is applied to the non-woven web material laminated to a polyurethane sponge foam and a washing process is simulated. After the wash cycle runs for a certain period of time, a sample of the water used for the wash is obtained. Subsequently, the same samples are subjected to a second wash cycle and when it ends, samples of the wash water are taken, and this process is repeated continuously until the final wash water has a surface tension very close or similar to that of water. The water then will contain a percentage of the foaming agent which was extracted from the non-woven web material laminated to the polyurethane sponge foam containing the foaming agent. Thus, the duration of the foaming agent concentration contained in the non-woven web material laminated to the polyurethane sponge foam can be estimated. The cycles appearing in FIG. 5 are equivalent in time to between 150 and 300 minutes. This time can be considered, under these conditions, as the time the foaming agent will last in the non-woven material laminated to the polyurethane sponge foam; however, it was found that, depending on the frequency and how is used by the final user, the product may present several different behaviors with respect to the time it takes the foaming agent to be totally extracted from the product containing it.

Table 2 shows the ranges of operating conditions recommended for the manufacturing of the non-woven material of the present invention.

TABLE 2

| Condition | Range | |
|---|---|---|
| Roller pressure-Application of adhesive by | 30-100 | kg/cm2 |
| means roller impregnation system. | | |
| Temperature of the oven used to cure the | 80-200° | C. |
| resins. | | |
| Recommended flow to spray the foaming | 1-3 | L/min |
| agent during the lamination step | | |

1-6. (canceled)

7. An abrasive article comprising:
a sponge foam base comprising: polyurethane, cellulose, polyethylene, melamine, polypropylene, or a combination thereof; and
a three-dimensional non-woven web comprising:
synthetic fibers or natural fibers;
abrasive particles; and
a first adhesive,
wherein the three-dimensional non-woven web is adhered to the sponge foam base with a second adhesive and wherein the cleaning article comprises a foaming agent that promotes foam generation when the cleaning article is utilized.

8. The abrasive article according to claim 7, wherein the foaming agent is an ionic, a nonionic, or an amphoteric surfactant of linear or branched structure, coco betaine, substituted mono-, di-, or tri-amines, or ethoxylated alcohols.

9. The abrasive article according to claim 7, wherein the foaming agent is within the non-woven web.

10. The abrasive article according to claim 7, wherein the foaming agent is within the sponge foam base.

11. The abrasive article according to claim 7, wherein the foaming agent is within the adhesive that adheres the sponge foam base to the non-woven web.

12. The abrasive article according to any one of claims 7, wherein the second adhesive is polyurethane-based, acrylic-based, epoxy-based, or a rubber resin.

13. The abrasive article according to any one of claims 7, wherein the foaming agent is microencapsulated.

14. The abrasive article according to any one of claims 7, wherein the abrasive particles comprise: silicas, carbonates, silicon, silicates, talcs, metal oxides, PVC, melamine, or a combination thereof.

15. A method of manufacturing an abrasive article according to claim 7 the method comprising:
applying a bonding agent to the fibers of the non-woven web, wherein the bonding agent comprises the first adhesive and the abrasive particles;
curing the bonding agent to form the non-woven web;
applying the foaming agent to the non-woven web or the sponge foam base; and bonding the non-woven web to the sponge foam base using the second adhesive.

16. The method according to claim 15, wherein the bonding agent is applied to the fibers of the non-woven web using rollers.
